(19) United States
(12) Patent Application Publication
(10) Pub. No.: US 2007/0216576 A1
(43) Pub. Date: Sep. 20, 2007

(54) Ultrasonic Football Linesman

(75) Inventor: Donald Alan Cass, Hillsboro, CA (US)

Correspondence Address: DONALD A. CASS, 801 SE OAK GLEN WAY, # 227, HILLSBORO, OR, 97123, US

(73) Assignee: Donald Alan Cass, Hillsboro, OR (US)

(21) Appl. No.: 11/308,264

(22) Filed: Mar. 14, 2006

(51) Int. Cl. G01S 3/02

(52) U.S. Cl. 342/453; 342/463; 342/465

(57) ABSTRACT

A portable system for measuring and positioning a football on the playfield is revealed. The system measures ultrasonic sound wave propagation delay and relates it to yardage. It corrects for wind errors by sending ultrasonic waves in both directions on the playfield and measures the difference.

### BACKGROUND OF THE INVENTION

Methods for determining the location of a football on the playfield are out of date and can be advanced by the introduction of modern technology. The use of chains to determine the distance left for a first down, and the use of eyeball judgment when centering the ball, can be modernized.

Some attempts at modernizing have been made but fall short because of their bulky arrangement, long cables, expensive apparatus, or fixed base requirements. A completely portable, quickly deployable system using inexpensive technology would be a great addition to the game.

### DESCRIPTION OF THE INVENTION

The system uses ultrasonic sound wave propagation delay as a means of measuring distance. It is composed of a portable unit carried by the official during the game, a group of Repeater Beacons placed around the perimeter of the playfield, and a base station located on the sideline.

After being set up as described above, the system is calibrated by taking the portable unit to a corner of the playfield at the end zone. It is triggered and an RF pulse and an ultrasonic pulse are emitted. The RF pulse alerts the Repeater Beacons and Base Unit that a measurement is under way. As each Repeater Beacon detects the ultrasonic wave, it retransmits an RF pulse, each on a separate frequency. When the Base Unit receives the initial RF pulse from portable unit, it starts a high speed counter. As the RF pulse from each of the Repeater Beacons is received, the count is recorded.

This is repeated at the other three corners of the playfield. The maximum and minimum delay time is now known as the portable unit is at its farthest and nearest point on the playfield from each of the Repeater Beacons. This data is converted into a mathematical algorithm by the Base Unit which relates these counts to playfield yardage.

When the game begins, the official can determine the location of the ball simply by placing the portable unit next to the nose of the ball and triggering it. The exact location of the ball is known and other measurements can be extracted, such as, the distance to go for a first down, total yardage, etc.

The system can be placed in a constant measurement mode that aids the official in centering the ball when a play ends out of bounds.

To compensate for errors entered into the system by wind, each of the Repeater Beacons can send out an ultrasonic burst of their own, each on a separate frequency, and be detected by the beacon on the other end of the playfield. The difference between the two propagation delays will be caused by the wind and is extracted from the measurement by factoring it into the algorithm.

The system does not require the playfield to be 100 yards long, 50 yards wide, or proportional to a regulation football field. It simple converts whatever distance is used during calibrated as the limits of the playfield and divides it up as if it were of regulation size (center of the field is called the 50 yard line, i.e.).

### PRIOR ART

U.S. Pat. No. 5,446,701 (Utke) describes a similar system but uses a reference receiver as an integral part of the measurement apparatus, not required in the system revealed here. The system revealed in this document eliminates the need for a reference receiver by adding the calibration step referred to in Claim 6. U.S. Pat. No. 5,446,701 also lacks the ability to accurately detect and compensate for errors created by wind as described in Claim 10 of this document, by measuring its effects in the long axis of the field where accuracy is needed. U.S. Pat. No. 5,446,701 also defines the location of the object being located in cylindrical and elliptical cylindrical coordinates, as opposed to simple Cartesian coordinates better suited to the use of trigonometric and algebraic principles for deriving ball position. The system revealed in this document also provides for measurement redundancy by making measurements from both end zone corners to both opposite end zone corners.

U.S. Pat. No. 5,346,210 (Utke) describes another similar system which relies on a calibration source or reference receiver, not needed in the system reveal in this document because of the information gained in the calibration step described in Claim 6. U.S. Pat. No. 5,346,210 Claim 1 describes a system requiring sensors to pick up ultrasonic signals as opposed to cordless repeater beacons as described in this document, which are more easily deployed. U.S. Pat. No. 5,346,210 Claims 21 and 31 describe different configurations using delay circuits, not required in the system revealed in this document.

U.S. Pat. No. 4,675,816 uses an RF radio beacon and triangulation from rotating antennas. It does not use ultrasonic sound.

U.S. Pat. No. 6,851,198 uses a laser for measurement instead of ultrasonic wave delay time.

U.S. Pat. No. 6,778,283 describes an optical system not related to this concept.

U.S. Pat. No. 4,989,341 describes a mechanical system with a chain and optical window, also not related to this concept.

What is claimed is:

1. A system used to measure the location of a football on the playfield including:
a) Said system has a portable control unit
b) Said system has four Repeater Beacons
c) Said system has a Base Unit.

2. Said system referred to in claim 1 has a portable control unit consisting of the following:
a. Said portable control unit has a plurality of RF transmitters and transceivers with antennas for communicating with said Base Unit and said Repeater Beacons
b. Said portable control unit has an ultrasonic transmitter
c. Said portable control unit has additional circuitry for controlling system functions
d. Said portable control unit has a power source.

3. Said Repeater Beacons referred to in claim 1 function as a wireless ultrasonic detectors and consists of the following:
a) Said Repeater Beacon has a plurality of ultrasonic receivers
b) Said Repeater Beacon has a plurality of ultrasonic transmitters
c) Said Repeater Beacon has an RF receiver with an antenna
d) Said Repeater Beacon has an RF transmitter with an antenna
e) Said Repeater Beacon has a power source.

4. Said system referred to in claim 1 has a Base Unit containing the following:
a) Said Base Unit has a plurality of RF receivers with antennas for detecting signals from said Repeater Beacons
b) Said Base Unit has a plurality of RF transceivers for communicating with the portable control unit
c) Said Base Unit has a plurality of arithmetic/logic circuits
d) Said Base Unit has a plurality of digital high speed clock counter circuits
e) Said Base Unit has a plurality of output circuits for sending controls signals to a scoreboard or display
f) Said Base Unit has a power source.

5. Said system referred to in claim 1 is setup as follows:
a) Said Repeater Beacons are placed at or near the corners of the playfield
b) Said Base Unit is place on the sideline
c) Said portable control unit is carried by the official.

6. Said system referred to in claim 1 is calibrated as follows:
a) Said portable control unit is taken to a corner of the playfield and made to emit an RF pulse and an ultrasonic pulse
b) Said Base Unit receives said RF pulse and starts said high speed clock counter
c) Said Repeater Beacons receive said RF pulse and turn on said transmitters
d) Said Repeater Beacons receive said ultrasonic pulse and transmit an RF pulse, each repeater beacon having a separate RF frequency
e) Said Base Unit receives said RF pulses from each of the Repeater Beacons and records the clock counter reading in said arithmetic/logic circuit
f) Said portable control unit is moved to the remaining three corners of the playfield and steps a through e are repeated
g) Said arithmetic/logic circuit uses the principles of algebra and trigonometry to create said mathematical algorithm using Cartesian coordinates which converts clock counter readings into playfield yardage.

7. Said system referred to in claim 1 is operated using the following steps:
a) Said portable control unit is carried by the official during the game
b) When a yardage measurement is required, the portable control unit is held next to the nose of the football and triggered
c) Upon receiving the initial RF pulse and the pulses from said Repeater Beacons, the Base Unit converts the present clock counter reading into present yardage
d) Said Base Unit sends the result to the output section for display or back to said portable control unit.

8. Said system referred to in claim 1 has a repeating measurement mode for the purpose of centering the football inside the hash marks on the playfield described as:
a) Said system is placed in a repeating measurement mode using said portable control unit after marking/spotting the ball as described in claim 7
b) The official carries the ball to the nearest hash mark
c) The official moves the portable control unit up and down the field while watching indicators, controlled by the Base Unit, pointing in the direction of the proper spot
d) The ball is placed at the proper spot and said system is changed back into measurement mode.

9. Said system referred to in claim 1 has a repeating measurement mode for the purpose of finding the proper point to spot the ball when a penalty is assessed including:
a) Said system is place in a repeating measurement mode using said portable control unit after marking/spotting the ball as described in claim 7
b) The official enters the penalty yardage to be assessed into said portable control unit
c) The official moves the portable control unit up and down the field while watching indicators, controlled by the Base Unit, pointing in the direction of the proper spot
d) The ball is placed at the proper spot and said system is changed back into measurement mode.

10. Said system referred to in claim 1 compensates for errors created by wind and environment by making a real time measurement of the conditions by:
a) Said Repeater Beacons have an ultrasonic transmitter each on a separate frequency
b) Said Repeater Beacons have an ultrasonic receiver, each tuned to sense the frequency transmitted by the Repeater Beacon on the opposite end, same side of the playfield
c) When a ball location measurement is under way, at the point when a Repeater Beacon sends out its RF pulse acknowledging the ultrasonic pulse from said portable control unit, it also sends out an ultrasonic burst on its individual frequency
d) Said Repeater Beacon receives the ultrasonic burst from the Repeater Beacon on the opposite end and sends out a second RF pulse
e) Said Base Unit receives said second pulse from each Repeater Beacon, each on its separate frequency, reads and stores said digital high speed clock counter readings
f) Said mathematical algorithm referred to in claim 6 corrects for errors by finding the difference between the counts from each end of the field, which should be equal if no wind exists, and factors the result into all of the location measurements referred to in claims 7, 8 and 9
g) Said mathematical algorithm compensates for changes in air density due to temperature by comparing ultrasonic propagation delay counter readings, referred to in step e, to readings taken during the initial calibration as described in claim 6.
